(19) United States
(12) Patent Application Publication
(10) Pub. No.: US 2006/0146088 A1
(43) Pub. Date: Jul. 6, 2006

(54) Ink jet printer service station having a selector valve

(76) Inventor: Brian Schick, San Diego, CA (US)

Correspondence Address: Mark G. Bocchetti;Patent Legal Staff, Eastman Kodak Company, 343 State Street, Rochester, NY, 14650-2201, US

(21) Appl. No.: 11/029,190

(22) Filed: Jan. 4, 2005

(51) Int. Cl. B41J 2/165

(52) U.S. Cl. 347/30

(57) ABSTRACT

Embodied herein is a service station for an ink jet printer including a print movable carriage supporting at least one printhead. The service station includes a sled having at least one wiper blade and at least one sealing cap attached to the sled. A selector valve selectively applies a vacuum at least one sealing cap in a first and a second operational state. A first operational state involves a vacuum through the at least one sealing cap to remove residue. A second operational state selectively applies vacuum through the cap to declog the printhead while in operation to keep the printhead from drying. A third operational state moves in a second direction, wherein the sled is held against the carriage allowing the orifice plate to be wiped as the carriage moves until it engages the plank releasing the sled to return to the first state.

### FIELD OF THE INVENTION

The present embodiments relate generally to a service station for a printhead.

### BACKGROUND OF THE INVENTION

In order to maintain the operability of an inkjet printer, it is necessary to periodically service the print heads. One important service which is performed is the cleaning of the print heads. The cleaning of the print heads reduces the buildup of ink on the print head which will dry and clog the jet openings on the print head. In addition, the cleaning of the print head reduces the dust and dirt which can accumulate on the print head and cause clogging. In a typical color inkjet printer, up to six colors of ink in up to six different ink cartridges are used. Typical cleaning methods employed involve jetting ink through all of the print head orifices into a waste receptacle to flush out stagnant ink and prevent drying and clogging. This function is commonly referred to as “spitting”. Wiper blades are also commonly used in many different configurations to scrape away excess ink.

A need exists for a service station that can be used to clean the printhead using vacuum while the printhead is in operation. The vacuum ideally can be applied directly to the orifice plate to provide a pressurized flush function and additionally can be used to remove waste ink generated during spitting. The embodiment of the present application meets these needs.

The present invention provides additional environmental, energy saving and labor savings as compared with the known art.

### SUMMARY OF THE INVENTION

A service station for an ink jet printer including a print movable carriage supporting at least one printhead with an orifice plate, the service station includes a sled with a plank. The sled is retained in slidable contact with a base unit and wherein the sled has at least one wiper blade; and at least one sealing cap attached to the sled. A selector valve can be mounted to the base unit. The selector valve selectively applies a vacuum from a vacuum source to at least one sealing cap.

The service station operates using a mechanical force from the print moveable carriage and the service station includes, a first operational state having the print moveable carriage entering the service station in a first direction 40, the selector valve applying vacuum to at least one sealing cap to remove spit residue while the printhead is in operation.

A second operational state has the print moveable carriage continuing in the first direction while the sled is in a second position to cap the orifice plate, the selector valve applies vacuum to at least one sealing cap to declog the printhead while the printhead is in operation or to keep the printhead from drying out while the printhead is not in operation.

A third operational state has the print moveable carriage reversing direction while maintaining the sled is held against the print moveable carriage the plank stopping the sled enabling the print moveable carriage to continues in the second direction such that the sled wipes the orifice plate with the wipers as the print moveable carriage leaves the service station and further wherein the print moveable carriage continues in the second direction until it engages the plank, releasing the sled to return to the first operational state.

The present embodiments are advantageous over the prior art because the device provides the use of a selective valve which can apply vacuum for continuous cleaning and efficient ink removable from the printhead while the printhead of the printing system is in operation, and while it is in a deactivated state.

### BRIEF DESCRIPTION OF THE DRAWINGS

In the detailed description of the preferred embodiments presented below, reference is made to the accompanying drawings, in which:

FIG. 1 depicts a perspective view of the service station with a print moveable carriage.

FIG. 2 is a perspective view of the service station with selector valve and actuator.

FIG. 3 depicts the print moveable carriage at the first operational state.

FIG. 4 depicts the print moveable carriage at the second operational state.

FIG. 5 depicts the print moveable carriage at the third operational state.

FIG. 6 depicts an exploded perspective view of an embodiment of the selector valve of the invention.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The present embodiments relate generally to a service station for a printhead.

A benefit of the service station with a selector valve and an additional vacuum source is that the orifice plate can be declogged while the printhead is operational, which lowers maintenance costs.

Another benefit of this service station is that this service station is more economical to operate and build than currently known service station which utilizes banks of electronically actuated individual valves.

The service station of the invention is environmentally friendly, in that waste is kept in liquid form to limit the presence of dust by dried ink, thereby improving the air quality for the operators of the printing systems in which the service station is utilized.

Another advantage of the invention is the system does not require a disposable ink receptacle cartridge when the service station of this invention is utilized. This embodiment saves on landfill space, and reduces the need to haul away the waste.

With the present invention, the operators do not have to perform maintenance, which is a significant benefit in creating a cost reduction from traditional methods where operators used hand held vacuum sources to clean the orifice plate and the printheads.

The embodiments of this invention are for a service station for an ink jet printer including a print movable carriage supporting at least one printhead with an orifice plate, the service station includes a sled with a plank. The sled is retained in slidable contact with a base unit and wherein the sled has at least one wiper blade; and at least one sealing cap attached to the sled.

The embodiments of this invention also include a selector valve that can be mounted to the base unit. The selector valve selectively applies a vacuum from a vacuum source to at least one sealing cap.

The service station operates using a mechanical force from the print moveable carriage and the service station. The service station includes, a first operational state having the print moveable carriage entering the service station in a first direction, the selector valve applying vacuum to at least one sealing cap to remove spit residue while the printhead is in operation.

A second operational state has the print moveable carriage continuing in the first direction while the sled is in a second position to cap the orifice plate, the selector valve applies vacuum to at least one sealing cap to declog the printhead while the printhead is in operation or to keep the printhead from drying out while the printhead is not in operation.

A third operational state has the print moveable carriage reversing direction while maintaining the sled is held against the print moveable carriage the plank stopping the sled enabling the print moveable carriage to continues in the second direction such that the sled wipes the orifice plate with the wipers as the print moveable carriage leaves the service station and further wherein the print moveable carriage continues in the second direction until it engages the plank, releasing the sled to return to the first operational state.

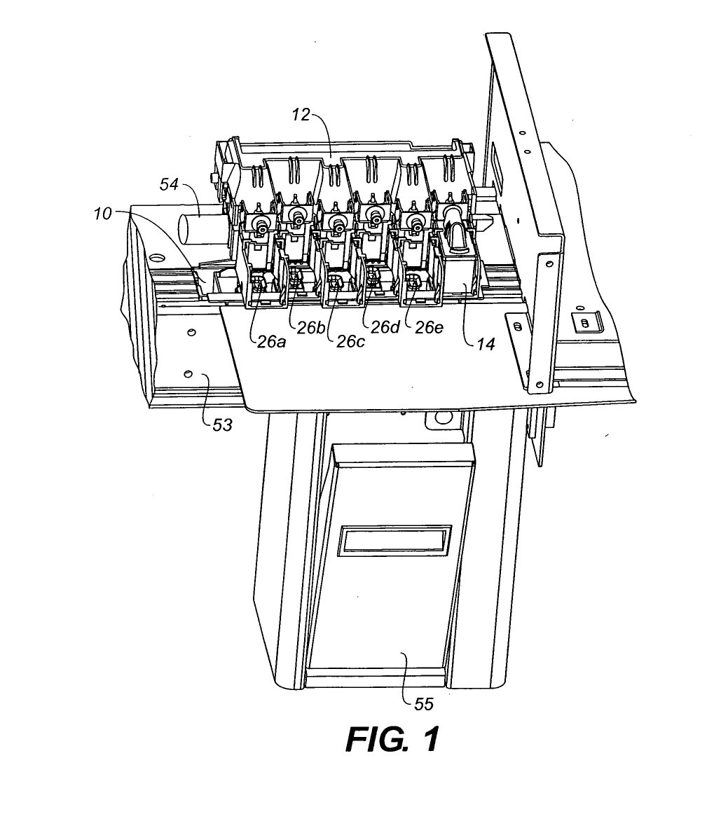

With reference to the figures, FIG. 1 depicts a service station 10 for an ink jet printer including a print movable carriage 12 with only one printhead shown 14, and the other printheads removed for clarity. The printhead of FIG. 1 shown is a cyan color printhead, and an example of a usable printhead could be a Lexmark printhead model number 82.

The FIG. 1 also shows other structures of the printer, a platen 53, a slide shaft 54 that the print moveable carriage rides upon. Sealing caps are also shown 26a, 26b, 26c, 26d and 26e that are used with the print moveable carriage at the first and second operational states.

Additionally, this figure shows a waste ink station 55 wherein waste ink receptacle resides for receiving waste ink removed through the action of the service station.

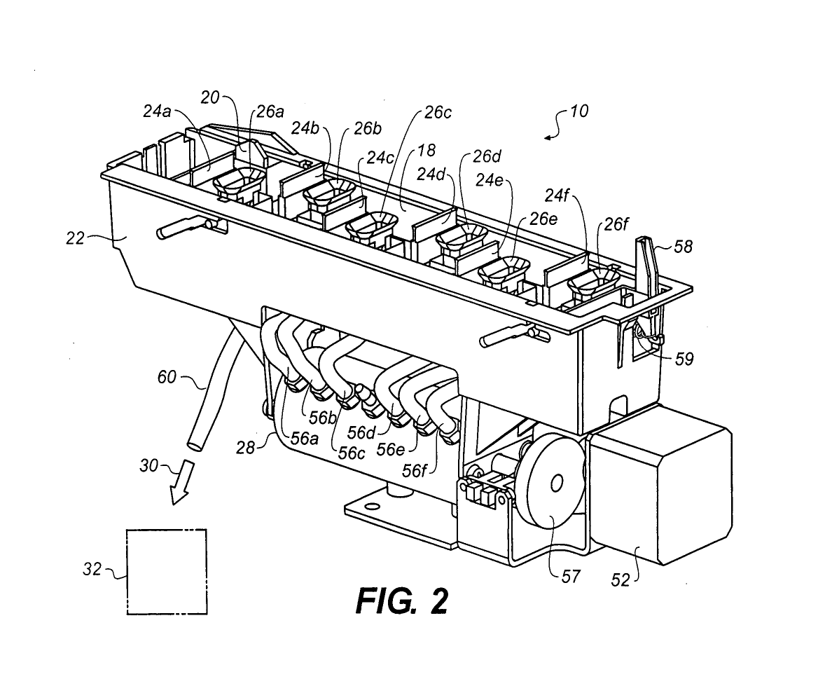

FIG. 2 shows perspective view of the service station 10 with the actuator 52. The actuator can be an electric motor, a pneumatic or hydraulic motor, or other device that provides movement to the selector valve 28 that is a component of the invention.

FIG. 2 shows a base unit 22 for the service station with the selector valve 28 and its associated tubing 56a, 56b, 56c, 56d, 56e, and 56f that connects the selector valve 28 to the sealing caps 26a, 26b, 26c, 26d, 26e and 26f.

FIG. 2 depicts a gear 57 used to transmit motion from the actuator 52 to the selector valve 28.

A sled 18 with the moveable plank 20 is depicted. The moveable plank 20 stops the motion of the sled enabling the orifice plate of the printhead to be wiped by wipers of the sled, removing ink from the orifice plate. The sled is in slidable contact with the base unit 22.

The sled is shown with a group of wipers, which can be wiper blades 24a, 24b, 24c, 24d, 24e and 24f attached to the sled. It is preferred that the sled is a structure that can hold and contain the wipers, the plank, and the sealing caps.

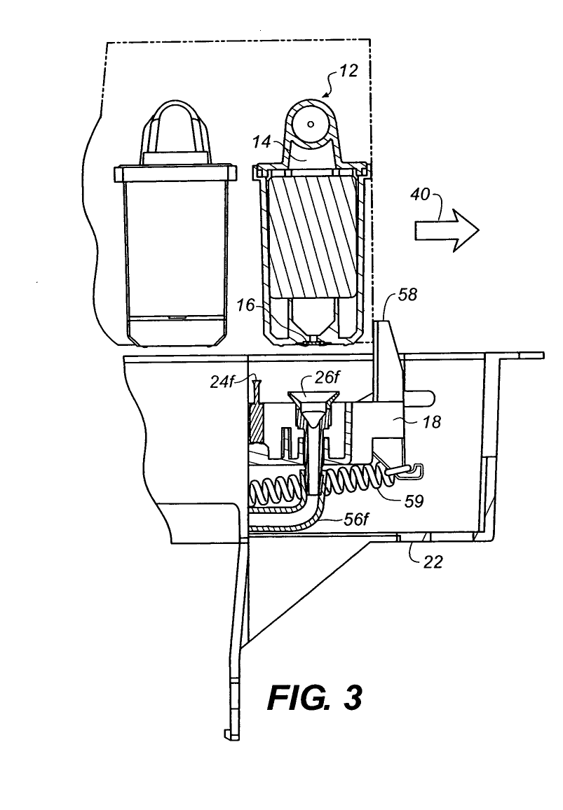

The sled 18, which is moveable, has a protrusion 58. The protrusions 58 is a molded feature of the sled body which makes contact to the movable print carriage of the printing system to transfer motion of the carriage to the sled so that the two units now move in tandem to a first operational state, which is shown in more detail in FIG. 3.

A spring 59 is shown. The spring 59 attaches to the base unit 22 on one end and the sled on the other end. This spring 59 is preferably an extension spring, which forces the sled to contract towards the print moveable carriage. The spring 59 enables the sled to maintain contact with the carriage as it moves away from the sled, in a second direction, which is the reverse of the first direction. This spring 59 operates to return the sled to the initial operation position after the carriage exits the service station.

The selector valve 28 is secured to the base unit 22. The selector valve 28 is connected to a vacuum source 32 using tubing 60. The selector valve 28 can selectively apply a vacuum 30 from the vacuum source 32 to at least one sealing cap, and six are shown as sealing caps 26a, 26b, 26c, 26d, 26e, and 26f.

FIG. 3 depicts the first operational state of the service station. The first operational state involves the print moveable carriage 12 with printhead 14 disposed on the carriage, entering the service station in a first direction 40. Vacuum can then be applied from the vacuum source shown in FIG. 2 to the sealing caps 26f. In the first operational state, spit residue is removed as it is ejected from the printhead 14. This figure also shows the orifice plate 16 of the printhead 14 that ejects the spit. Other parts of the service station shown in FIG. 2 are also identified in this FIG. 3.

It should be noted that one sealing cap per printhead can be used to remove spit residue from the orifice plate. Any number of printheads with associated sealing caps can be employed in this method and service station.

Spit is ink that is ejected from the printhead for cleaning purposes. Spit is jetted through the orifice plate during normal printing operations.

A sled 18 is depicted in this Figure as well as some of the other elements of the prior Figures. The sled 18 is preferably an injection molded, plastic custom part usable in the printing system provided by any number of normal sources, such as suppliers that perform injection molding of custom parts.

A protrusion 58 of the sled 18 can be seen in the figure. A spring 59 attaches to the sled. A wiper blade 24f is shown next to a sealing cap 26f. The sealing cap is connected by tubing 56f inside the base unit 22. It is preferred that the tubing be flexible, plastic tubing.

It is particularly noted that mechanical force from the print moveable carriage is used to operate the service station.

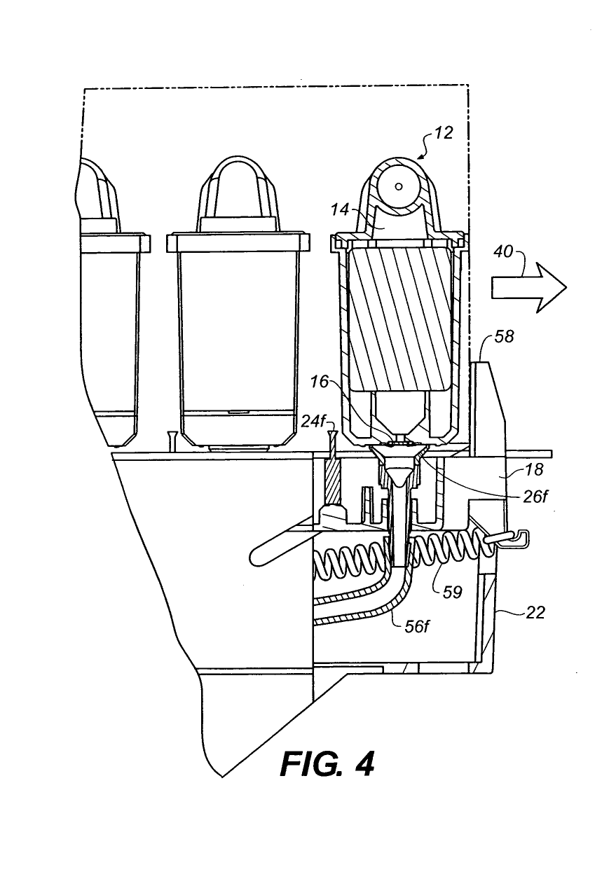

FIG. 4 depicts a second operational state of the service station which shows the print moveable carriage 12 continuing in the first direction 40 while the sled 18 is in a capping position, which may be referred to here as a second position, to cap the orifice plate 16.

In this second operational position, the selector valve shown in prior figures, provides vacuum through tubing 56f, selectively applying vacuum through at least one sealing cap 26f The vacuum is used to declog the printhead 14 while the printhead is in operation. The vacuum can be used to keep the printhead 14 from drying out while the printhead is not in operation.

FIG. 4 also shows many of the elements mentioned in the prior figures, including the sled 18, wiper 24f on the sled, the base unit 22 and the spring 59 attached to the sled 18 with the protrusion 58.

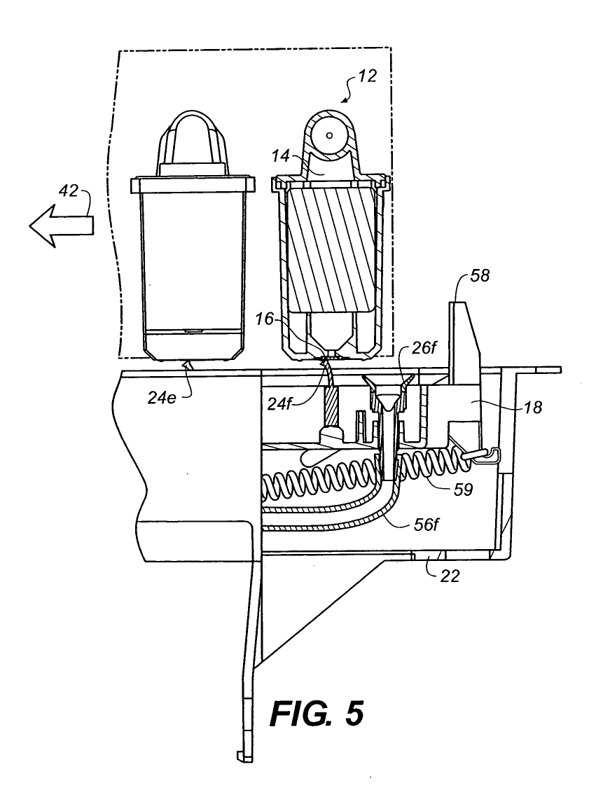

FIG. 5 shows a third operational state of the service station which involves the print moveable carriage 12 with printhead 14 moving in a second direction 42 that is the reverse of the first direction.

While the print moveable carriage moves in the second direction 42, the sled 18 is held against the print moveable carriage 12 and is then stopped by the plank 20 that was depicted in a prior figure. The action of the plank 20, not shown in FIG. 5, allows the print moveable carriage 12 to continue in the second direction 42, while the sled 18 is stopped. By stopping the sled, the orifice plate 16 is wiped by wipers on the sled, shown here as wiper blades 24e and 24f as the print moveable carriage continues to move in a second direction and leave the service station. It is contemplated that as many wipers can be used as there are printheads.

FIG. 5 also shows many of the elements mentioned in prior figures, including the sled 18 with protrusion 58, the base unit 22 and the spring 59. The sealing cap 26f with tubing 56f is also shown although it is not used in this operational state.

As the print moveable carriage continues in the second direction until it ultimately engages a camming surface of the plank. The plank, when engaged in the second direction releases the sled to return to the first operational state.

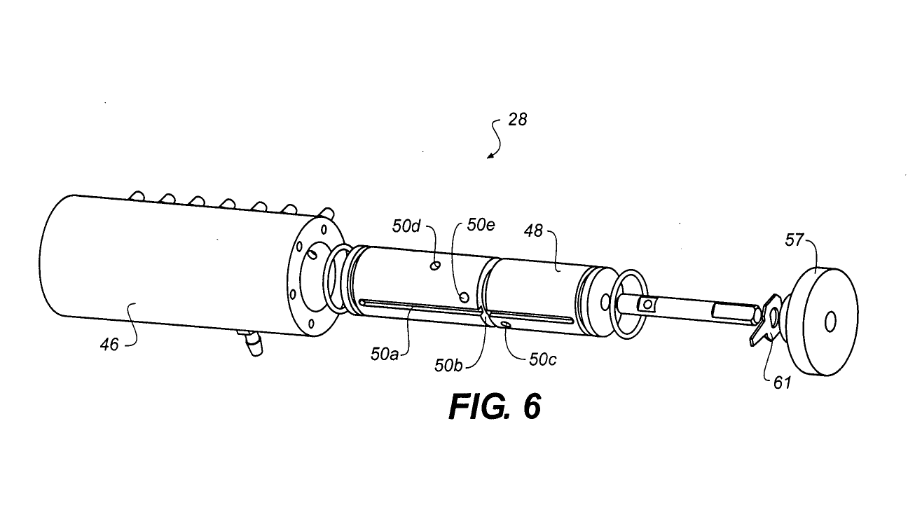

FIG. 6 is a detailed view of the selector valve 28 usable in this invention.

FIG. 6 depicts hole and groove features 50a, 50b, 50c, 50d and 50e in the spool 48 that selectively communicate vacuum to a central manifold in the spool which has the vacuum applied to it.

At the spool 48 rotates, the holes align with port features in a sleeve 46 that surrounds the spool 48 to selectively apply vacuum to any combination of sealing caps.

The radial hole and groove features in the spool 48 are in fluid communication with the vacuum source and convey vacuum to the valve. The group of hole and groove features 50a, 50b, 50c, 50d, and 50e allow the selection of vacuum application to individual sealing caps.

A sleeve 46 surrounds the spool 48 and allows the spool 48 to rotate within the sleeve. The rotation is preferably a bi-directional rotation. Additional fittings and seals are shown in this Figure. FIG. 6 depicts a gear 57 that is usable to operate the selective valve. A flag 61 is also shown in the Figure. This flag 61 can be used to determine a start position for the actuator 52, which is depicted in FIG. 2. In a preferred embodiment, the flag can be a stamped sheet metal artifact that can be used as an interrupter in an optical switch used in the ink jet printing system.

The selector valve produces a closed state which is a sealed off condition that isolates the sealing caps from any pressure or other influences outside the service station. The selector valve also provides a vacuum connected state to at least one sealing cap for the service station. It is also contemplated that the selector valve can connect to a third state, a venting state for the service station. If the selector provides a venting connection, the valve vents positive pressure generated in the capping action to the atmosphere.

The selector valve preferably is rotationally driven by an actuator shown in FIG. 2. The actuator can be an electric motor, a pneumatic actuator, a hydraulic actuator or any other type that can provide motion. It can also be noted that the selector valve can be spherical rather than cylindrical in shape.

In still another embodiment, it is contemplated that a vacuum can be applied to the caps simultaneously as the orifice plate is wiped.

It is contemplated that the vacuum applied is between 10 and 25 inches of mercury.

Finally, it is contemplated that the vacuum source can be a diaphragm vacuum pump, peristaltic pump, centrifugal pump, or a positive displacement pump.

The invention has been described in detail with particular reference to certain preferred embodiments thereof, but it will be understood that variations and modifications can be effected within the spirit and scope of the invention.

### PARTS LIST

10. service station
12. print moveable carriage
14. printhead
16. orifice plate
18. sled
20. plank
22. base unit
24a. first wiper blade
24b. second wiper blade
24c. third wiper blade
24d. fourth wiper blade
24e. fifth wiper blade
24f. sixth wiper blade
26a. first sealing cap
26b. second sealing cap
26c. third sealing cap
26d. fourth sealing cap
26e. fifth sealing cap
26f. sixth sealing cap
28. selector valve
30. vacuum
32. vacuum source
36. first operational state
38. second operational state
39. third operational state
40. first direction
42. second direction
46. sleeve
48. spool
50a. one of the group of hole and groove features
50b. another of the group of hole and groove features
50c. another of the group of hole and groove features
50d. another of the group of hole and groove features
50e. another of the group of hole and groove features
52. actuator
53. platen
54. slide shaft
55. waste ink station
56a. tubing from selector valve
56b. tubing from selector valve
56c. tubing from selector valve
56d. tubing from selector valve
56e. tubing from selector valve
56f. tubing from selector valve
57. gear
58. protrusion
59. spring
60. tubing
61. flag

1. A service station (10) for an ink jet printer including a print movable carriage (12) supporting at least one printhead (14) having an orifice plate (16), wherein the service station (10) operates using a mechanical force from the print moveable carriage (12),wherein the service station (10) comprises:
a. a sled (18) comprising a plank (20), wherein the sled (18) is retained in slidable contact with a base unit (22), and wherein the sled (18) has at least one wiper blade (24); and
b. at least one sealing cap (26) attached to the sled (18);
c. a selector valve (28) mounted to the base unit (22), wherein the selector valve (28) selectively applies a vacuum (30) from a vacuum source (32) to the at least one sealing cap (26), and wherein the service station (10) comprises:
i. a first operational state comprising:
1. moving the print moveable carriage (12) in a first direction (40) into the service station (10); and
2. applying vacuum through the selector valve (28) to at least one sealing cap (26) to remove spit residue while the printhead (14) operates;
ii. a second operational state comprising:
1. moving the print moveable carriage (12) further in the first direction (40) and capping the orifice plate (16); and
2. using the selector valve (28) to apply vacuum to at least one sealing cap (26) to de-clog the printhead while the printhead (14) operates or to keep the printhead (14) from drying out while the printhead (14) is not operating;
iii. a third operational state comprising:
1. reversing the print moveable carriage (12) direction while holding the sled (18) against the print moveable carriage (12); and
2. stopping the sled (18) with a plank enabling the print moveable carriage (12) to continue in the second direction such that the sled (18) wipes the orifice plate (16) with the wipers as the print moveable carriage (12) leaves the service station (10), and wherein the print moveable carriage (12) continues in the second direction until the print moveable carriage (12) engages the plank; and wherein the plank releases the sled (18) to return to the first operational state.

2. The service station of claim 1, further comprising applying a vacuum to the at least one sealing cap for de-clogging and spit removal.

3. The service station of claim 1, wherein the selector valve comprises a sleeve having fluid channels to connect to the at least one sealing cap and a spool in fluid connected with the vacuum, wherein the spool is rotationally fit into the sleeve.

4. The service station of claim 3, wherein the spool comprises a group of hole and groove features 50 which allow changes in the direction of vacuum flow to the caps.

5. The service station of claim 1, wherein the selector valve comprises a closed state, and a vacuum connected state, wherein the vacuum is applied to the at least one sealing cap.

6. The service station of claim 1, wherein the selector valve is rotationally driven by an actuator.

7. The service station of claim 1, wherein the vacuum is between 10 and 25 inches of mercury.

8. The service station of claim 1, wherein the selector valve is a spherical valve.

9. The service station of claim 1, wherein the vacuum source is a diaphragm vacuum pump, a peristaltic pump, a centrifugal pump, or a positive displacement pump.
